(19) United States
(12) Patent Application Publication
(10) Pub. No.: US 2021/0027267 A1
(43) Pub. Date: Jan. 28, 2021

(54) INFORMATION PROCESSING DEVICE, INFORMATION PROCESSING METHOD, AND STORAGE MEDIUM

(71) Applicant: NEC Corporation, Minato-ku, Tokyo (JP)

(72) Inventor: Keiji HASEGAWA, Tokyo (JP)

(73) Assignee: NEC Corporation, Minato-ku, Tokyo (JP)

(21) Appl. No.: 16/979,653

(22) PCT Filed: Mar. 13, 2019
(86) PCT No.: PCT/JP2019/010413

§ 371 Date: Sep. 10, 2020

(30) Foreign Application Priority Data
Mar. 16, 2018 (JP) 2018-049503

(51) Int. Cl. G06Q 20/20; G07G 1/12

(52) U.S. Cl. CPC G06Q 20/20; G07G 1/12

(57) ABSTRACT

An information processing device according to the present invention includes: a detection unit that detects a connection state between at least one POS terminal that is removable from a support stand and the support stand; and a request unit that, when the connection state is a disconnected state, requests the POS terminal or a user terminal linked in advance to the POS terminal to connect the POS terminal to the support stand.

### TECHNICAL FIELD

The present invention relates to an information processing device, an information processing method, and a storage medium.

### BACKGROUND ART

Patent Literature 1 discloses a POS register formed of a device base and a terminal device that is removable from the device base. Similarly, Patent Literature 2 discloses a POS terminal device in which an ordering terminal (terminal device) also serves as an LCD display unit and the ordering terminal is removable from the POS base. The terminal device disclosed in each patent literature can be used alone as an operation terminal for ordering operations, inventorying operations, or the like when removed from the device base (support stand).

### CITATION LIST

### Patent Literature

PTL 1: Japanese Patent Application Laid-open No. 2014-41559

PTL 2: Japanese Patent Application Laid-open No. 2002-183834

### SUMMARY OF INVENTION

### Technical Problem

In the devices disclosed in Patent Literature 1 and Patent Literature 2, even when a user wants to use the removable terminal device and the support stand as an integrated device, there may be no terminal device connected to the support stand. For example, the POS register disclosed in Patent Literature 1 is unable to be used as a cash register when the terminal device has been removed from the device base (support stand). Thus, when the number of PS registers that can be used as cash registers is smaller than the number of customers waiting for payment, help for checkout is called by in-store announcement, for example. However, it is difficult to determine a salesclerk carrying a terminal device and quickly call the salesclerk.

The present invention has been made in view of the above problem and intends to provide an information processing device, an information processing method, and a storage medium that can quickly request a salesclerk using a POS terminal removed from a support stand to connect the POS terminal to a support stand.

### Solution to Problem

According to one example aspect of the present invention, provided is an information processing device including: a detection unit that detects a connection state between at least one POS terminal that is removable from a support stand and the support stand; and a request unit that, when the connection state is a disconnected state, requests the POS terminal or a user terminal linked in advance to the POS terminal to connect the POS terminal to the support stand.

### Advantageous Effects of Invention

According to the present invention, an information processing device, an information processing method, and a storage medium that can quickly request a salesclerk using a POS terminal removed from a support stand to connect the POS terminal to a support stand are provided.

### BRIEF DESCRIPTION OF DRAWINGS

FIG. 1 is a schematic diagram illustrating a POS system using an information processing device according to a first example embodiment of the present invention.

FIG. 2 is a block diagram illustrating a hardware configuration example of the information processing device according to the first example embodiment of the present invention.

FIG. 3 is a function block diagram illustrating a configuration example of the information processing device according to the first example embodiment of the present invention.

FIG. 4 is a diagram illustrating an example of terminal management information stored in a storage unit in the first example embodiment of the present invention.

FIG. 5 is a perspective view illustrating a state where a POS terminal is connected to a support stand in the first example embodiment of the present invention.

FIG. 6 is a perspective view illustrating a state where the POS terminal is removed from the support stand in the first example embodiment of the present invention.

FIG. 7 is a flowchart illustrating an example of a process of the information processing device according to the first example embodiment of the present invention.

FIG. 8 is a diagram illustrating an example of a help request window displayed on the POS terminal in the first example embodiment of the present invention.

FIG. 9 is a diagram illustrating an example of a notification window displayed on the POS terminal in the first example embodiment of the present invention.

FIG. 10 is a schematic diagram illustrating a POS system using an information processing device according to a second example embodiment of the present invention.

FIG. 11 is a diagram illustrating an example of terminal management information stored in a storage unit in the second example embodiment of the present invention.

FIG. 12 is a diagram illustrating an example of a notification window displayed on a user terminal in the second example embodiment of the present invention.

FIG. 13 is a function block diagram illustrating a configuration example of an information processing device according to a third example embodiment of the present invention.

FIG. 14 is a flowchart illustrating an example of a process in the information processing device according to the third example embodiment of the present invention.

FIG. 15 is a function block diagram illustrating a configuration example of an information processing device according to a fourth example embodiment of the present invention.

FIG. 16 is a flowchart illustrating an example of a process in the information processing device according to the fourth example embodiment of the present invention.

FIG. 17 is a function block diagram illustrating a configuration example of an information processing device according to a fifth example embodiment of the present invention.

FIG. 18 is a diagram illustrating an example of a terminal management information stored in a storage unit in the fifth example embodiment of the present invention.

FIG. 19 is a flowchart illustrating an example of the process in the information processing device according to the fifth example embodiment of the present invention.

FIG. 20 is a function block diagram illustrating a configuration example of an information processing device according to a sixth example embodiment of the present invention.

### DESCRIPTION OF EMBODIMENTS

Example embodiments of the present invention will be described below with reference to the drawings. Note that, in the drawings described below, components having the same function or a corresponding function are labeled with the same references, and the repeated description thereof will be omitted.

### First Example Embodiment

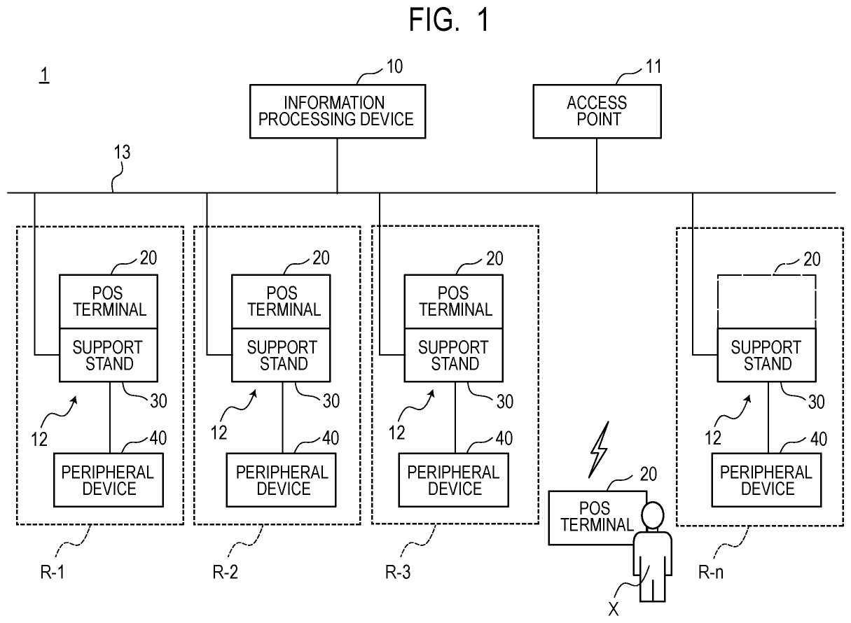

FIG. 1 is a schematic diagram illustrating a POS system 1 using an information processing device 10 according to the present example embodiment. The information processing device 10 according to the present example embodiment is used as a shop server in the POS system 1 introduced in a shop where products are sold. As illustrated in FIG. 1, the POS system 1 includes the information processing device 10, an access point 11, and POS devices 12. The information processing device 10, the access point 11, and the POS devices 12 are connected to a network 13 that is a local area network (LAN), for example.

The information processing device 10 is a shop server that performs management of information on products sold in the shop, aggregation of sales data, management of proceeds, management of inventory, or the like and manages the operation of the POS system 1 (store controller), for example. The information processing device 10 is installed in a backyard of the shop, for example. The information processing device 10 manages data of product information or the like used in the POS device 12.

The access point 11 is a wireless communication device that wirelessly communicates with a POS terminal 20 in a disconnected state and connects the POS terminal 20 to the network 13. The access point 11 is installed on a ceiling or the like of the shop, for example. Further, one or a plurality of access points 11 may be installed in accordance with the scale of the shop, a radio environment, or the like, for example.

Each POS device 12 of the present example embodiment has the POS terminal 20 and a support stand 30 that supports the POS terminal 20 in a removable manner. The POS devices 12 are installed at register counters R-1 to R-n (n≥2) in the shop, respectively. Note that the number of POS devices 12 is not particularly limited, and any number can be installed in accordance with the scale of the shop or the like. A peripheral device 40 is connected to each support stand 30. The installation place of the support stand 30 is not particularly limited. The support stand 30 can also be installed at a place other than the register counters R-1 to R-n of the shop.

The POS terminal 20 is an information device such as a tablet terminal or the like that can be carried by a salesclerk who is an operator. FIG. 1 illustrates that a salesclerk X uses the POS terminal 20 removed from the support stand 30 of the register counter R-n. The POS terminal 20 can be used in both cases where the connection state is “connected” and “disconnected”. That is, the POS terminal 20 can be used by a salesclerk when attached to the support stand 30 installed at any of the register counters R-1 to R-n of the shop. Further, the POS terminal 20 can be carried and used by a salesclerk not only at the register counters R-1 to R-n of the shop but also at a place other than the register counters R-1 to R-n of the shop when removed from the support stand 30.

The POS terminal 20 attached to the support stand 30 is connected to the network 13 by a wire via the support stand 30. Thereby, the POS terminal 20 can transmit and receive data to and from the information processing device 10 or other external devices by wired communication. Note that the connection between the POS terminal 20 and the network 13 is not limited to the above and may be connected wirelessly.

The peripheral device 40 is a processing device attached to the support stand 30. For example, the peripheral device 40 includes a code scanner, a contactless integrated circuit (IC) reader/writer, a printer, a cash drawer, or the like. The POS terminal 20 in the connected state can control the peripheral device 40 via the support stand 30.

In such a way, the support stand 30 functions as a cradle or a docking station that is an extended unit that extends the function of the POS terminal 20 attached thereto.

On the other hand, the POS terminal 20 in the disconnected state removed from the support stand 30 is connected to the network 13 by wireless communication with the access point 11. Thereby, the POS terminal 20 in the disconnected state can transmit and receive data to and from the information processing device 10 or other external devices via the network 13 by wireless communication. Note that the connection between the POS terminal 20 in the disconnected state and the network 13 is not limited to the above.

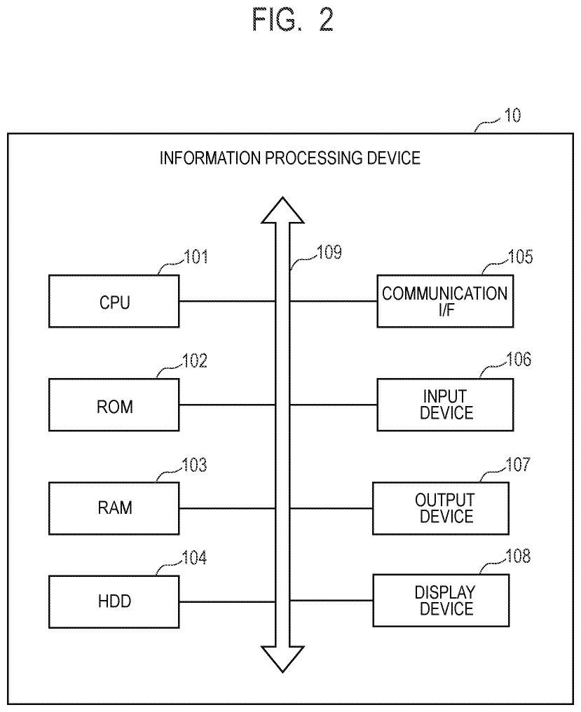

FIG. 2 is a block diagram illustrating a hardware configuration example of the information processing device 10 according to the present example embodiment. As illustrated in FIG. 2, the information processing device 10 has a central processing unit (CPU) 101, a read only memory (ROM) 102, a random access memory (RAM) 103, a hard disk drive (HDD) 104, a communication interface (I/F) 105, an input device 106, an output device 107, and a display device 108. Each component is connected to a common bus line 109.

The CPU 101 controls the overall operation of the information processing device 10. Further, the CPU 101 loads a program stored in the HDD 104 or the like to the RAM 103 and executes the program. Thereby, the CPU 101 implements the functions as a terminal state detection unit 10a, a help request acceptance unit 10c, and a connection request unit 10d described later.

The ROM 102 stores programs such as a boot program. The RAM 103 is used as a working area when the CPU 101 executes a program.

Further, the HDD 104 is a storage device that stores process results in the information processing device 10 and various programs executed by the CPU 101. The storage device is not limited to an HDD 104 as long as it is nonvolatile. The storage device may be, for example, a flash memory or the like. In the present example embodiment, the HDD 104, the ROM 102, and the RAM 103 realize a function as a storage unit 10b described later.

The communication I/F 105 controls data communication with a device connected to the network 13. The communication I/F 105 realizes a function as the terminal state detection unit 10a, the help request acceptance unit 10c, and the connection request unit 10d together with the CPU 101.

The input device 106 is a human interface such as a keyboard, a mouse, or the like, for example. Further, the input device 106 may be a touch panel embedded in the display device 108. The user of the information processing device 10 is able to input a setting of the information processing device 10, input an execution instruction of a process, or the like via the input device 106.

The output device 107 is a device that outputs predetermined information in accordance with a signal from the CPU 101. The output device is a speaker, a printer, or the like, for example.

The display device 108 is a device that displays predetermined information in accordance with a signal from the CPU 101. As the display device 108, a liquid crystal display or the like may be used.

Note that the information processing device 10 may further have another device without limited to the hardware configuration illustrated in FIG. 2. The information processing device 10 may be formed of a single or a plurality of devices or may be formed integrally with another device. Further, the information processing device 10 may be connected to another device, and at least a part of the process performed by the information processing device 10 in the present example embodiment may be performed by the device.

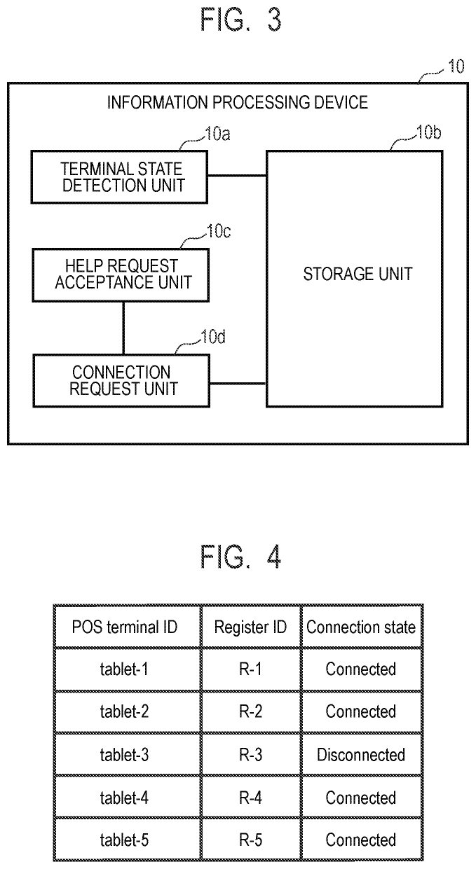

FIG. 3 is a function block diagram illustrating a configuration example of the information processing device 10 according to the present example embodiment. The information processing device 10 has the terminal state detection unit 10a, the storage unit 10b, the help request acceptance unit 10c, and the connection request unit 10d.

The terminal state detection unit 10a detects the connection state between the POS terminal, which is removable from the support stand 30, and the support stand 30. The terminal state detection unit 10a detects whether or not the POS terminal 20 and the support stand 30 are electrically and physically connected to each other. The detection method may be a method such as (1) or (2) below, for example. However, the detection method is not limited thereto.

(1) The terminal state detection unit 10a detects the connection state between the POS terminal 20 and the support stand 30 via wireless communication with the POS terminal 20. For example, each POS terminal 20 detects the connection state between the subject terminal and the support stand 30 by using a built-in removal sensor (not illustrated) and stores the connection state in the storage device. In such a case, the terminal state detection unit 10a can detects the connection state by performing inquiry to the POS terminal 20 by wireless communication.

(2) The terminal state detection unit 10a detects the connection state between the POS terminal 20 and the support stand 30 by determining whether or not communication with the POS terminal 20 is available via the support stand 30. For example, when wired communication with the POS terminal 20 via the support stand 30 is available, it can be determined that the connection state between the POS terminal 20 and the support stand 30 is “connected”. In contrast, when wired communication with the POS terminal 20 via the support stand 30 is unavailable, it can be determined that the connection state between the POS terminal 20 and the support stand 30 is “disconnected”.

The storage unit 10b is a storage device that stores terminal management information on the plurality of POS terminals 20. FIG. 4 is a diagram illustrating an example of terminal management information stored by the storage unit 10b in the present example embodiment. Herein, terminal management information having data items of POS terminal ID, register ID, and a connection state is illustrated. The POS terminal ID is a data item that identifies the POS terminal 20. The register ID is a data item that identifies the register counters R-1 to R-n in which the support stands 30 are installed. The connection state is a data item indicating the connection state (connected/disconnected) between the POS terminal 20 and the support stand 30. For example, for the POS terminal 20 of the POS terminal ID “tablet-3”, it is indicated that the connection state to the support stand 30 installed in the register counter R-3 of the register ID “R-3” is “disconnected”.

The help request acceptance unit 10c accepts a help request input from the POS terminal 20 via the network 13. Note that the help request acceptance unit 10c may accept a help request input from a device other than the POS terminal 20.

When the connection state of a POS terminal 20 is “disconnected”, the connection request unit 10d requests the POS terminal 20 for connection to the support stand 30. Further, the connection request in the present example embodiment is triggered by input of a help request from the POS terminal 20 and notified after the POS terminal 20 whose connection state is “disconnected” is determined. Therefore, when a help request is input to the help request acceptance unit 10c by any of the POS terminals 20 connected to the support stand 30 out of the plurality of POS terminals 20, the connection request unit 10d requests only the POS terminal 20 whose connection state is “disconnected” out of the plurality of POS terminals 20 for a connection.

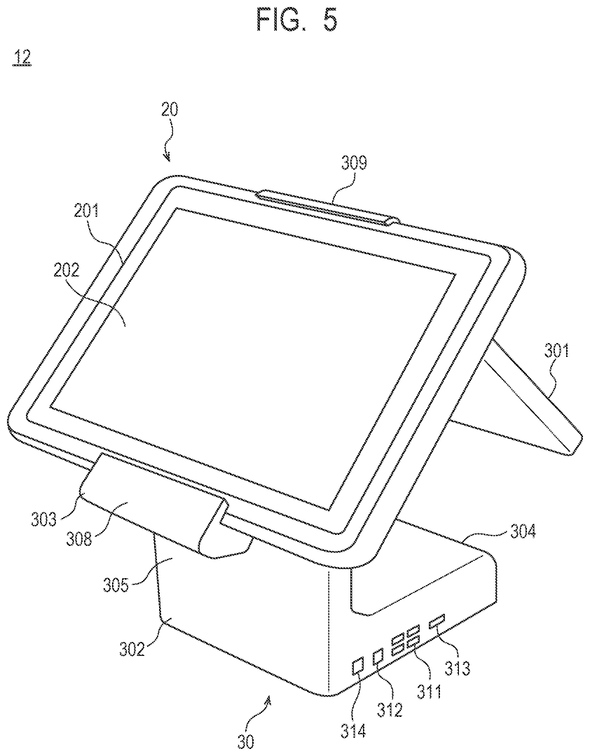

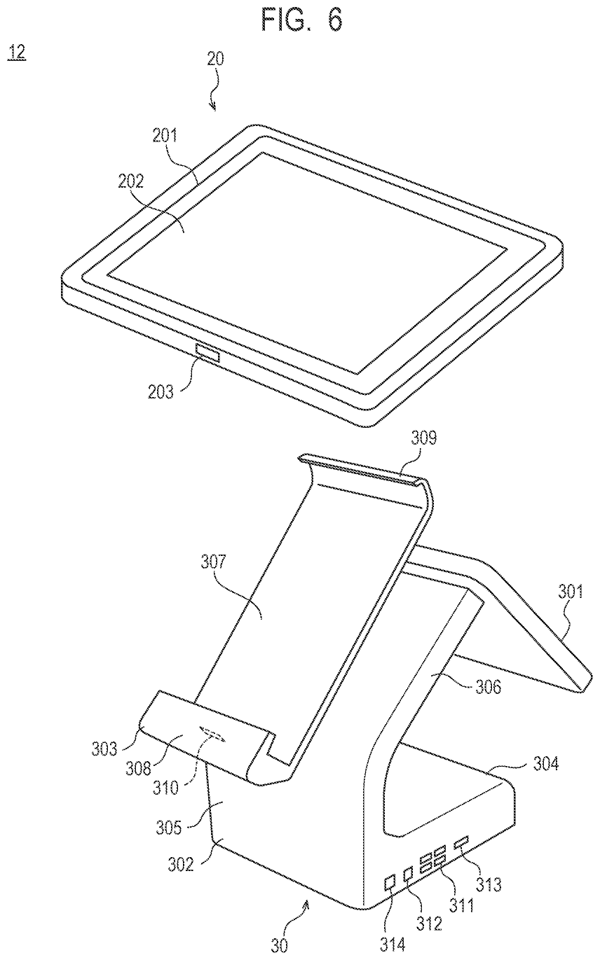

Subsequently, the configuration of the POS device 12 in the present example embodiment will be described with reference to FIG. 5 and FIG. 6. FIG. 5 is a perspective view illustrating a state where the POS terminal 20 is attached to the support stand 30. FIG. 6 is a perspective view illustrating a state where the POS terminal 20 is removed from the support stand 30.

The POS terminal 20 has a rectangular plate-like external shape and has a display screen 202 of a rectangular touch panel 201 corresponding to the external shape. The support stand 30 has a display 301, a base part 302, and a holder part 303 and supports the POS terminal 20.

The display 301 displays various information such as payment information in a display screen (not illustrated) to a customer under the control of the POS terminal 20. The payment information displayed on the display 301 may be, for example, a name of a product processed for payment, a quantity of the product, a selling price, a discount price, a total amount, a tax amount, a receipt amount, a change amount, or the like.

The base part 302 functions as a support member that supports the POS terminal 20 and the display 301. Furthermore, the base part 302 functions as a casing that accommodates a power source, an external interface (I/F), or the like therein.

The base part 302 has a bottom portion 304 placed on an installation place such as the register counters R-1 to R-n or the like and a plate-like leg portion 305 extending upward from one end of the bottom portion 304. A slope portion 306 inclined toward the other end side of the bottom portion 304 with respect to the perpendicular direction is provided to the upper part of the leg portion 305.

As illustrated in FIG. 5 and FIG. 6, the holder part 303 has a back-support portion 307 and a pair of hook portions 308 and 309 provided to the lower end and the upper end of the back-support portion 307. The holder part 303 functions as a support member of the POS terminal 20 by holding the POS terminal 20 by the pair of the hook portions 308 and 309. The pair of the hook portions 308 and 309 are formed of an elastically deformable material, which enables easy attachment and removal of the POS terminal 20 with respect to the holder part 303.

Further, a connector 310 is provided to the holder part 303. The connector 310 is a connector used for electrically connecting the POS terminal 20 to the support stand 30. In the example of FIG. 6, the connector 310 is provided to the lower hook portion 308 of the holder part 303. When a connector 203 provided to the POS terminal 20 is connected to the connector 310, the POS terminal 20 is electrically and physically connected to the support stand 30.

Further, a Universal Serial Bus (USB) connector 311, a communication connector 312, a display terminal 313, and a power supply connector 314 are provided in the lower side part of the base part 302. Note that the installation place of each terminal is not particularly limited.

As the peripheral device 40, for example, a code scanner, a contactless IC reader/writer, a printer, a cash drawer, or the like may be connected to the USB connector 311.

A communication cable such as a LAN cable is connected to the communication connector 312. The communication connector 312 is a LAN connector such as RJ-45, for example. The support stand is connected to the network 13 via a communication cable connected to the communication connector 312.

An external display is connected to the display terminal 313. The display terminal 313 is, for example, a High-Definition Multimedia Interface (HDMI) (registered trademark) terminal, a Digital Visual Interface (DVI) terminal, a Video Graphics Array (VGA) terminal, or the like.

An alternating current (AC) adapter is connected to the power supply connector 314. The AC adapter converts AC power from commercial power supply into DC power and supplies the DC power to the support stand 30.

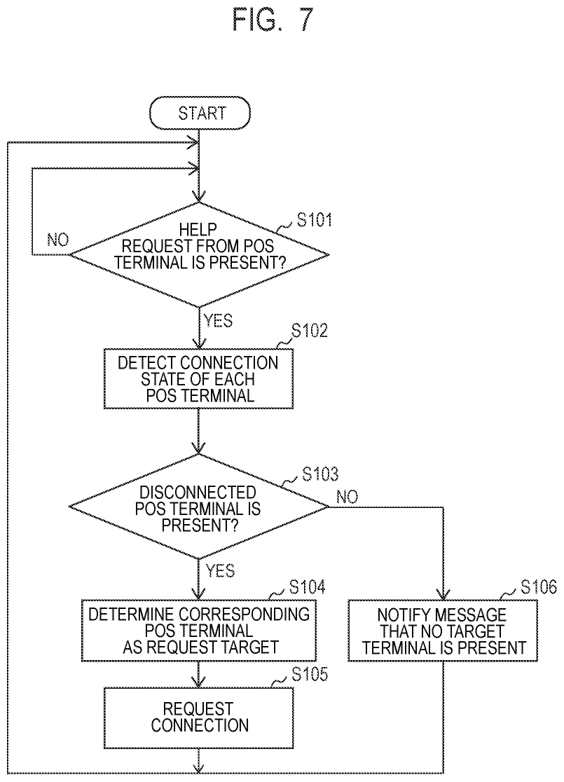

The operation of the information processing device 10 according to the present example embodiment will be described below with reference to FIG. 7 to FIG. 9. FIG. 7 is a flowchart illustrating an example of the process in the information processing device 10 according to the present example embodiment. This process is repeatedly performed within a shop opening hours, for example.

First, the help request acceptance unit 10c determines whether or not input of a help request from any of the plurality of POS terminals 20 is present (step S101).

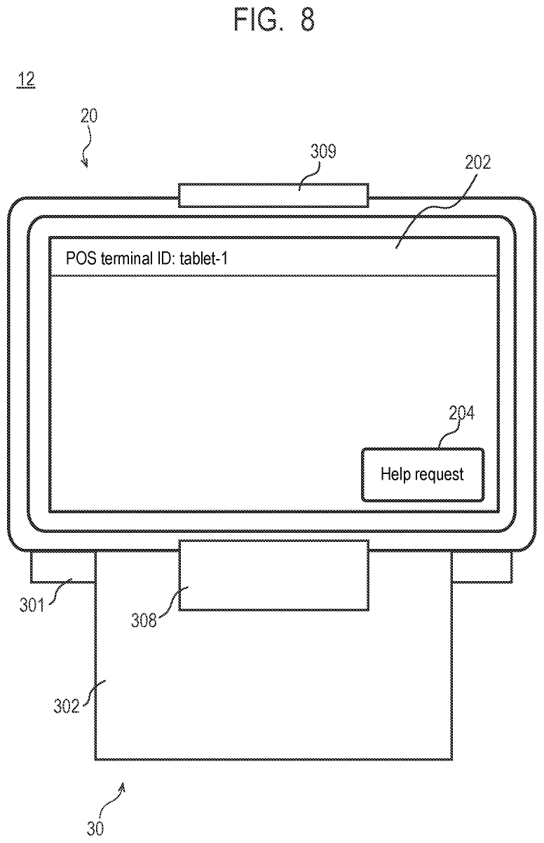

FIG. 8 is a diagram illustrating an example of a help request window displayed on the POS terminal 20 in the present example embodiment. In this example, a help request window (display screen 202) is displayed on the POS terminal 20 connected to the support stand 30. In the help request window, POS terminal ID (“tablet-1”) and a help request button 204 are displayed. When a salesclerk who is an operator of the POS terminal 20 presses the help request button 204 in accordance with the congestion status of the register, the help request acceptance unit 10c determines that a help request is input.

Next, if the help request acceptance unit 10c determines that a help request from the POS terminal 20 is input (step S101: YES), the process proceeds to a process of step S102. In contrast, if the help request acceptance unit 10c determines that no help request from the POS terminal 20 is input (step S101: NO), the process repeats the process of step S101.

In step S102, the terminal state detection unit 10a detects the connection state from each POS terminal 20 to the support stand 30. At this time, the terminal state detection unit 10a stores the detected connection state in the storage unit 10b.

Next, the connection request unit 10d references the storage unit 10b in response to receiving a determination result in the help request acceptance unit 10c and determines whether or not the POS terminal 20 whose connection state is “disconnected” is present (step S103). Herein, if the connection request unit 10d determines that the POS terminal 20 whose connection state is “disconnected” is present (step S103: YES), the connection request unit 10d determines the corresponding POS terminal 20 as a request target (step S104) and requests a connection (step S105), and the process then returns to the process of step S101.

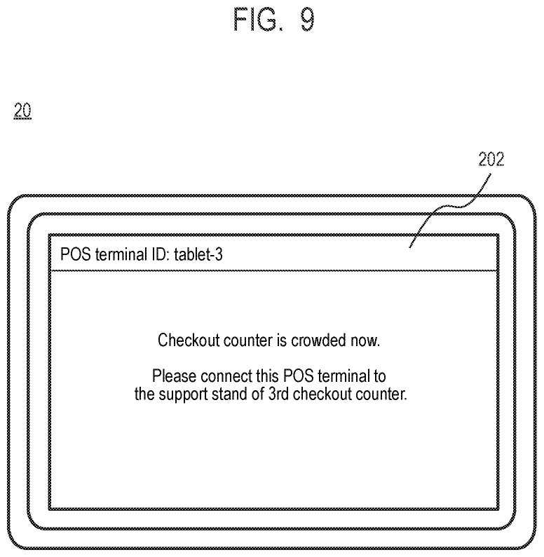

FIG. 9 is a diagram illustrating an example of a notification window displayed on the POS terminal 20 in the present example embodiment. In this example, a message for a connection request is displayed in a notification window (display screen 202) in the POS terminal 20 removed from the support stand 30. On the display screen 202, POS terminal ID (“tablet-3”) and a connection request message (“Checkout counter is crowded now. Please connect this POS terminal to the support stand of 3rd checkout counter.”) are displayed. The salesclerk who is the operator of the corresponding POS terminal 20 will connect the POS terminal 20 to the support stand 30 in accordance with the message on the display screen 202.

In contrast, if the connection request unit 10d determines that the POS terminal 20 whose connection state to the support stand 30 is “disconnected” is not present (step S103: NO), the connection request unit 10d notifies the POS terminal 20 issuing the help request of a message indicating that no target terminal is present (step S106), and the process then returns to the process of step S101.

As described above, according to the information processing device 10 of the present example embodiment, it is possible to quickly request a salesclerk using the POS terminal 20 removed from the support stand 30 to connect the POS terminal 20 to the support stand 30. That is, it is not necessary to request all the salesclerks for a help by in-store announcement or the like, and it is possible to notify only the salesclerk using the POS terminal 20 in the disconnected state. As a result, it is possible to increase the number of registers in operation in a short time and reduce the waiting time of customers for payment.

### Second Example Embodiment

An information processing device 50 according to a second example embodiment will be described below. Note that references common to the references provided in the drawings of the first example embodiment refer to the same object. Thus, description of features common to those of the first example embodiment will be omitted, and different features will be described in detail.

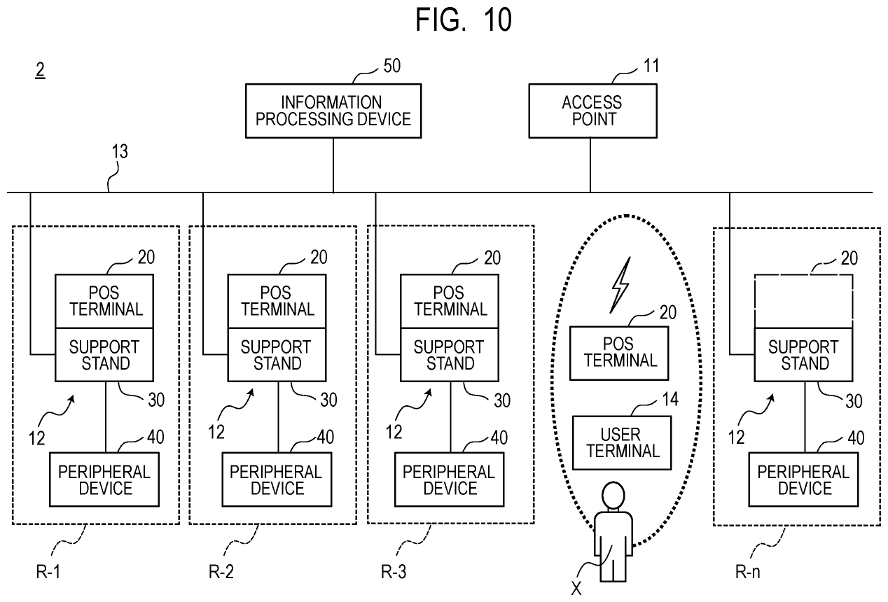

FIG. 10 is a schematic diagram illustrating a POS system 2 using the information processing device 50 according to the present example embodiment. It is illustrated here that a salesclerk X is using the POS terminal 20 removed from the support stand 30 of the register counter R-n. Further, FIG. 10 also illustrates that the salesclerk X carries a user terminal 14 having a communication function, such as a smartphone, together with the POS terminal 20. Note that, to directly notify the user terminal 14 carried by each salesclerk, a contact address is pre-stored in the storage unit 10b in the present example embodiment.

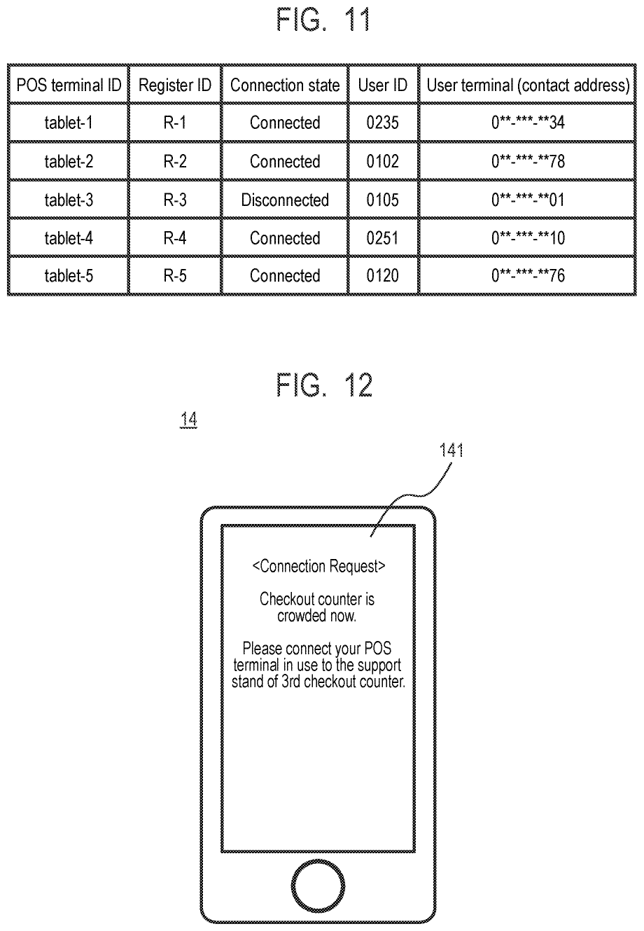

FIG. 11 is a diagram illustrating an example of terminal management information stored in the storage unit 10b in the present example embodiment. In this example, terminal management information having data items of POS terminal ID, register ID, a connection state, user ID, and a user terminal (contact address) is illustrated. The POS terminal ID is a data item that identifies the POS terminal 20. The register ID is a data item that identifies the register counters R-1 to R-n at which the support stands 30 are installed. The user ID is a data item that identifies a salesclerk using the POS terminal 20. The user terminal (contact address) is a data item indicating a contact address related to the user terminal 14. For example, the POS terminal 20 of the POS terminal ID “tablet-3” is being used by a salesclerk of user ID “0105”, and the connection state to the support stand 30 is “disconnected”. Further, the contact address of the user terminal 14 carried by the above salesclerk is telephone number “0**-***-**01”. The contact address is not limited to a telephone number but may be a mail address or the like.

Further, when the connection state is “disconnected”, the connection request unit 10d of the present example embodiment requests the user terminal 14 linked in advance to the POS terminal 20 to connect the POS terminal 20 to the support stand 30. That is, the request target for a connection in the present example embodiment is different from the first example embodiment.

FIG. 12 is a diagram illustrating an example of a notification window displayed on the user terminal 14 in the present example embodiment. In this example, a notification window 141 is displayed on the user terminal 14. In the notification window 141, a connection request message (“Checkout counter is crowded now. Please connect your POS terminal in use to the support stand of 3rd checkout counter.”) is displayed. The salesclerk who is the operator of the corresponding POS terminal 20 will connect the POS terminal 20 in use to the support stand 30 in accordance with the message in the notification window 141.

Although the process of the information processing device 50 according to the present example embodiment is the same as the flowchart of FIG. 7 described above, only step S104 is different. In the case of the present example embodiment, the connection request unit 10d references the storage unit 10b and determines a contact address of the user terminal 14 associated in advance with the POS terminal 20 whose connection state is “disconnected” as a request target for a connection.

As described above, according to the information processing device 50 of the present example embodiment, instead of the POS terminal 20 whose connection state is “disconnected”, the user terminal 14 carried by a salesclerk using that POS terminal 20 can be requested for a connection. Thus, the user terminal 14 is used as a request target even when a request to the POS terminal 20 is not possible, the request can be reliably made.

### Third Example Embodiment

An information processing device 60 according to a third example embodiment will be described below. Note that references common to the references provided in the drawings of the first example embodiment refer to the same object. Thus, description of features common to those of the first example embodiment will be omitted, and different features will be described in detail.

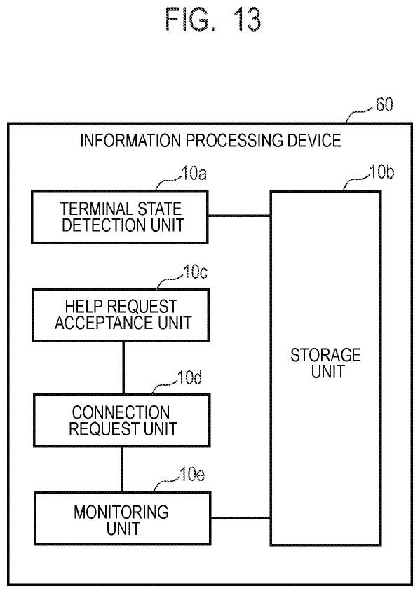

FIG. 13 is a function block diagram illustrating a configuration example of the information processing device 60 according to the present example embodiment. As illustrated in FIG. 13, the information processing device 60 differs from that of the first example embodiment in further having a monitoring unit 10e that monitors a customer in a shop. The monitoring unit 10e monitors the waiting state of customers by analyzing an image of customers captured in the shop by an image capture device (not illustrated) such as a camera. Note that the monitoring method may use not only analysis of a captured image but also a detection result from various sensors such as an infrared sensor, a laser sensor, or the like. Further, the connection request unit 10d of the present example embodiment requests a connection when the POS terminal 20 whose connection state is “disconnected” is present and the number of customers reaches a predetermined number. That is, the information processing device 60 of the present example embodiment differs from that of the first example embodiment in automatically notifying the POS terminal 20 in the disconnected state in accordance with a congestion status in the shop. Note that the condition for automatic notification can be arbitrarily defined.

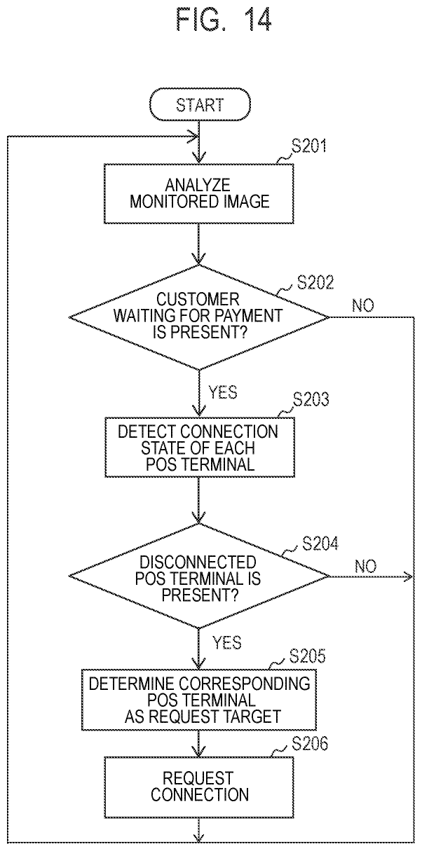

The operation of the information processing device 60 according to the present example embodiment will be described below with reference to FIG. 14. FIG. 14 is a flowchart illustrating an example of the process in the information processing device 60 according to the present example embodiment. This process is repeatedly performed within the shop opening hours, for example.

First, the monitoring unit 10e analyzes a monitoring image in the shop acquired from the image capture device (step S201) and determines whether or not a customer waiting for payment is present in a region near the register counters R-1 to R-n, for example (step S202). Herein, if the monitoring unit 10e determines that a customer waiting for payment is present (step S202: YES), the process proceeds to a process of step S203. In contrast, if the monitoring unit 10e determines that no customer waiting for payment is present (step S202: NO), the process returns to the process of step S201.

In step S203, the terminal state detection unit 10a detects a connection state from each POS terminal 20 to the support stand 30. At this time, the terminal state detection unit 10a stores the detected connection state in the storage unit 10b.

Next, the connection request unit 10d references the storage unit 10b in response to a determination result in the monitoring unit 10e and determines whether or not the POS terminal 20 whose connection state is “disconnected” is present (step S204). Herein, if the connection request unit 10d determines that the POS terminal 20 whose connection state is “disconnected” is present (step S204: YES), the connection request unit 10d determines the corresponding POS terminal 20 as a request target (step S205) and requests a connection (step S206), and the process then returns to the process of step S201. In contrast, if the connection request unit 10d determines that the POS terminal 20 whose connection state to the support stand 30 is “disconnected” is not present (step S204: NO), the process then returns to the process of step S201.

Thus, according to the information processing device 60 of the present example embodiment, it is possible to detect a waiting state of a customer in a shop and automatically request the POS terminal 20 in the disconnected state for a connection without requiring input of a help request from a salesclerk. Thus, when a predetermined congestion situation occurs, uniform and quick action is possible.

### Fourth Example Embodiment

An information processing device 70 according to a fourth example embodiment will be described below. Note that references common to the references provided in the drawings of the first example embodiment refer to the same object. Thus, description of features common to those of the first example embodiment will be omitted, and different features will be described in detail.

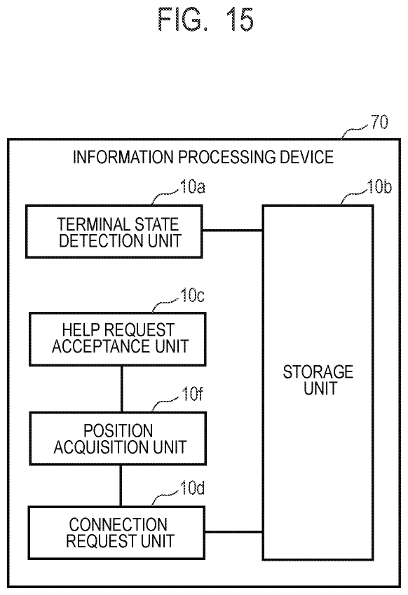

FIG. 15 is a function block diagram illustrating a configuration example of the information processing device 70 according to the present example embodiment. The information processing device 70 differs from that of the first example embodiment in further having a position acquisition unit 10f. The position acquisition unit 10f acquires the position of the POS terminal 20 in a shop. For example, the position acquisition unit 10f acquires the position of the POS terminal 20 in the shop via wireless communication with the POS terminal 20. For the position acquisition unit 10f, a short-range wireless technology such as Beacon may be used, for example. Further, the position information may be acquired together with the connection state of the POS terminal 20. Note that the position acquisition unit 10f may omit acquisition of position information for the POS terminal 20 connected to the support stand 30.

Further, the connection request unit 10d of the present example embodiment differs from the first example embodiment in determining a target for a connection request based on predetermined priority order. Specifically, when a plurality of POS terminals 20 whose connection states are “disconnected” are present, the connection request unit 10d requests the POS terminal 20 whose position is closer to the support stand 30 with priority for a connection. Note that the priority order of a connection request may be determined based on information other than the position information. For example, the priority order of a connection request may be determined based on a usage frequency of the POS terminal 20, right or wrong of the combination of the POS terminal 20 and the support stand 30, or the like.

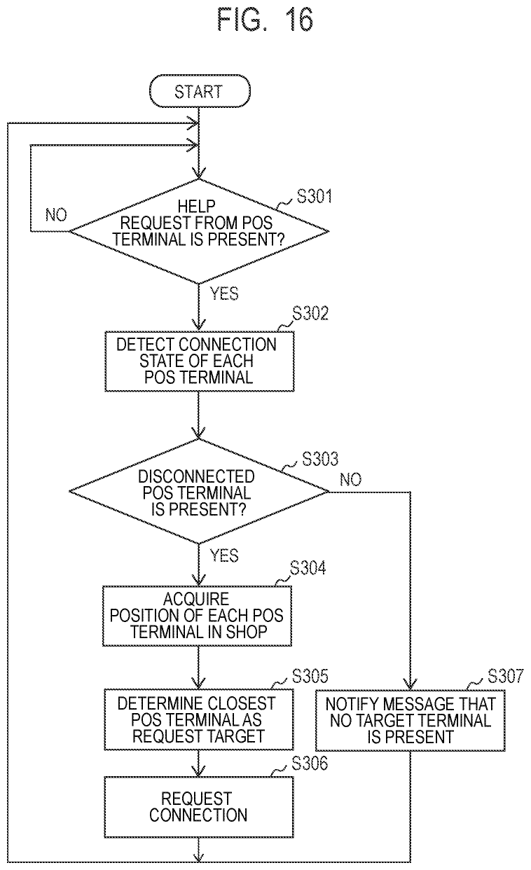

The operation of the information processing device 70 according to the present example embodiment will be described below with reference to FIG. 16. FIG. 16 is a flowchart illustrating an example of the process of the information processing device 70 according to the present example embodiment. This process is repeatedly performed within the shop opening hours, for example.

First, the help request acceptance unit 10c determines whether or not a help request from any of the plurality of POS terminals 20 is input (step S301). Herein, if the help request acceptance unit 10c determines that a help request from any of the plurality of POS terminals 20 is input (step S301: YES), the process proceeds to a process of step S302. In contrast, if the help request acceptance unit 10c determines that no help request from any of the plurality of POS terminals 20 is input (step S301: NO), the process repeats the process of step S301.

In step S302, the terminal state detection unit 10a detects a connection state from each POS terminal 20 to the support stand 30. At this time, the terminal state detection unit 10a stores the detected connection state in the storage unit 10b.

Next, the connection request unit 10d references the storage unit 10b in response to receiving a determination result in the help request acceptance unit 10c and determines whether or not the POS terminal 20 whose connection state is “disconnected” is present (step S303). Herein, if the connection request unit 10d determines that the POS terminal 20 whose connection state is “disconnected” is present (step S303: YES), the process proceeds to a process of step S304.

In step S304, the position acquisition unit 10f acquires the position of the POS terminal 20 in the shop by wireless communication with the POS terminal whose connection state is “disconnected” and outputs the position information to the connection request unit 10d. Note that, when only one POS terminal 20 in the disconnected state is present, the process of step S304 may be omitted.

Next, the connection request unit 10d determines, as a request target, the POS terminal 20 whose position is the closest to the support stand 30 to be connected out of the plurality of POS terminals 20 based on the position information input from the position acquisition unit 10f (step S305) and requests a connection (step S306), and the process then returns to the process of step S301.

In contrast, if the connection request unit 10d determines that the POS terminal 20 whose connection state to the support stand 30 is “disconnected” is not present (step S303: NO), the connection request unit 10d notifies the POS terminal 20 issuing the help request of a message indicating that no target terminal is present (step S307), and the process returns to the process of step S301.

As described above, according to the information processing device 70 of the present example embodiment, when a help request is input from the POS terminal 20 or the like, and when a plurality of POS terminals 20 in the disconnected state that are notification candidates are present, the POS terminal 20 close to the support stand 30 to be connected can be requested for a connection with priority taking the position of the plurality of POS terminals 20 into consideration. Thus, the time to increase registers in operation can be further reduced.

### Fifth Example Embodiment

An information processing device 80 according to a fifth example embodiment will be described below. Note that references common to the references provided in the drawings of the first example embodiment refer to the same object. Thus, description of features common to those of the first example embodiment will be omitted, and different features will be described in detail.

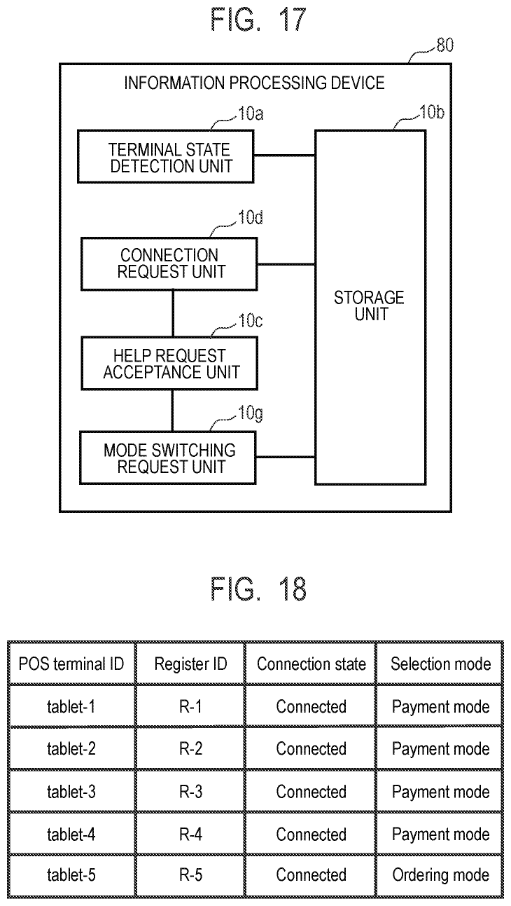

FIG. 17 is a function block diagram illustrating a configuration example of the information processing device 80 according to the present example embodiment. As illustrated in FIG. 17, the information processing device 80 differs from that of the first example embodiment in further having a mode switching request unit 10g.

Further, the terminal state detection unit 10a of the present example embodiment acquires not only the connection state between the POS terminal 20 and the support stand 30 but also a selection mode in each POS terminal 20. The terminal state detection unit 10a stores the acquired selection mode in the storage unit 10b.

FIG. 18 is a diagram illustrating an example of data stored in the storage unit 10b in the present example embodiment. In this example, terminal management information having data items of POS terminal ID, register ID, a connection state, and a selection mode is illustrated. The POS terminal ID is a data item that identifies the POS terminal 20. The register ID is a data item that identifies the register counters R-1 to R-n in which the support stands 30 are installed. The connection state is a data item indicating the connection state (connected/disconnected) between the POS terminal 20 and the support stand 30. The selection mode is a data item indicating an operation mode (function) selected by a salesclerk at each POS terminal 20.

When a help request is input to the help request acceptance unit 10c, the mode switching request unit 10g acquires a selection mode in the POS terminal 20 connected to the support stand 30 from the storage unit 10b. When the POS terminal 20 whose selection mode is other than “payment mode” is present in the POS terminals 20 in the connection state, the mode switching request unit 10g requests the corresponding POS terminal 20 to switch the mode.

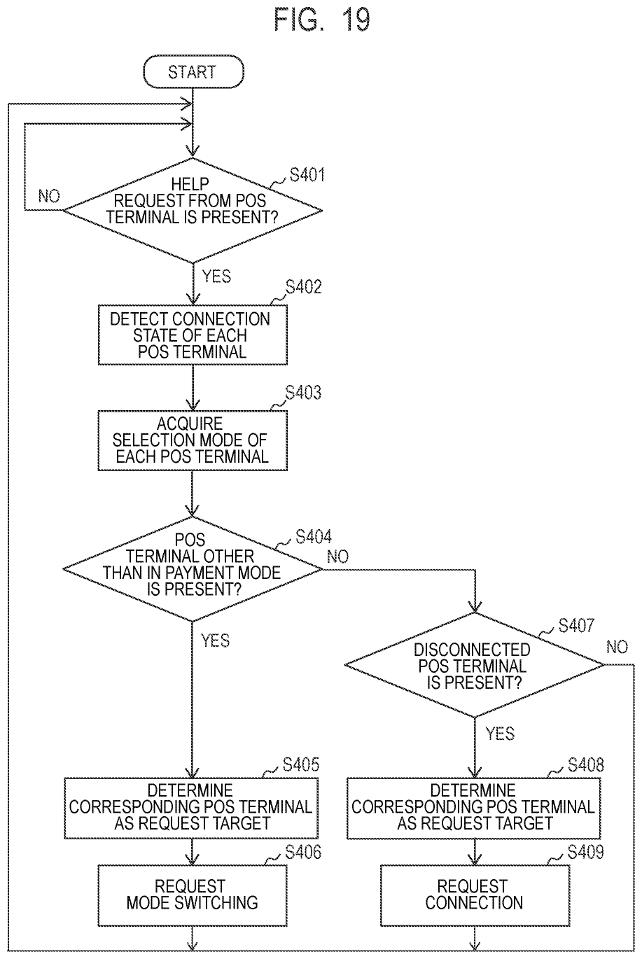

The operation of the information processing device 70 according to the present example embodiment will be described below with reference to FIG. 19. FIG. 19 is a flowchart illustrating an example of the process of the information processing device 80 according to the present example embodiment. This process is repeatedly performed within the shop opening hours, for example.

First, the help request acceptance unit 10c determines whether or not a help request from any of the plurality of POS terminals 20 is input (step S401). Herein, if the help request acceptance unit 10c determines that a help request from any of the plurality of POS terminals 20 is input (step S401: YES), the process proceeds to a process of step S402. In contrast, if the help request acceptance unit 10c determines that no help request from any of the plurality of POS terminals 20 is input (step S401: NO), the process repeats the process of step S401.

In step S402, the terminal state detection unit 10a communicates with each POS terminal 20 wirelessly or by a wire and detects a connection state from each POS terminal 20 to the support stand 30. At this time, the terminal state detection unit 10a stores the detected connection state in the storage unit 10b.

Next, the terminal state detection unit 10a communicates with each POS terminal 20 wirelessly or by a wire and acquires a selection mode at each POS terminal 20 (step S403). At this time, the terminal state detection unit 10a stores the acquired selection mode in the storage unit 10b.

Next, the mode switching request unit 10g references the storage unit 10b in response to receiving a determination result in the help request acceptance unit 10c and determines whether or not the POS terminal 20 whose selection mode is other than “payment mode” is present (step S404). Herein, if the connection request unit 10d determines that the POS terminal 20 whose selection mode is other than “payment mode” is present (step S404: YES), the connection request unit 10d determines the corresponding POS terminal 20 as a request target (step S405) and notifies the corresponding POS terminal 20 of the mode switching request (step S406), and the process then returns to the process of step S401. For example, in the data example of FIG. 18, at the POS terminal 20 having the POS terminal ID “tablet-5”, the connection state is “connected” while the selection mode is “ordering mode”. In such a case, by requesting the corresponding POS terminal 20 to switch the mode to “payment mode”, it is possible to urge the salesclerk to switch the mode.

In contrast, if the mode switching request unit 10g determines that the POS terminal 20 whose selection mode is other than “payment mode” is not present (step S404: NO), the process proceeds to a process of step S407.

In step S407, the connection request unit 10d references the storage unit 10b in response to receiving a determination result in the help request acceptance unit 10c and determines whether or not the POS terminal 20 whose connection state is “disconnected” is present. Herein, if the connection request unit 10d determines that the POS terminal 20 whose connection state is “disconnected” is present (step S407: YES), the connection request unit 10d determines the corresponding POS terminal 20 as a request target (step S408) and requests a connection (step S409), and the process then returns to the process of step S401. In contrast, if the connection request unit 10d determines that the POS terminal 20 whose connection state to the support stand 30 is “disconnected” is not present (step S407: NO), the process returns to the process of step S401.

As described above, according to the information processing device 80 of the present example embodiment, when the total number of operating registers is short, it is possible to determine the POS terminal 20 in a mode other than a payment mode out of the POS terminals 20 connected to the support stand 30 and request the POS terminal 20 to switch the mode (function switching). As a result, notification can be performed also for the POS terminal 20 in the connected state in order to increase the total number of operating registers. Further, since a request target for mode switching is the POS terminal 20 in the connected state and it is not necessary to move the POS terminal 20, there is an advantage that the number of operating registers can be easily and quickly increased.

### Sixth Example Embodiment

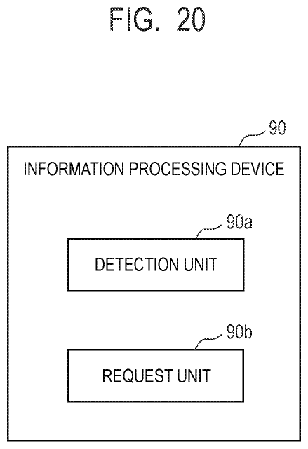

An information processing device 90 according to a sixth example embodiment will be described below. FIG. 20 is a function block diagram illustrating a configuration example of the information processing device 90 according to the present example embodiment. The information processing device 90 has a detection unit 90a that detects a connection state between a POS terminal that is removable from a support stand and the support stand and a request unit 90b that, when the connection state is a disconnected state, requests the POS terminal or a user terminal linked in advance to the POS terminal to connect the POS terminal.

According to the information processing device 90 of the present example embodiment, it is possible to quickly request a salesclerk using a POS terminal removed from a support stand to connect the POS terminal to a support stand.

### Modified Example Embodiments

While the present invention has been described above with reference to the example embodiments, the present invention is not limited the example embodiments described above. Various modifications that can be understood by those skilled in the art can be made to the configuration and details of the present invention without departing from the spirit of the present invention. For example, it should be appreciated that an example embodiment in which a part of the configuration of any of the example embodiments is added to another example embodiment or an example embodiment in which any of the example embodiments is replaced with a part of the configuration of another example embodiment is also one of the example embodiments to which the present invention may be applied.

Further, the scope of each of the example embodiments further includes a processing method that stores, in a storage medium, a program that causes the configuration of each of the example embodiments to operate so as to implement the function of each of the example embodiments described above, reads the program stored in the storage medium as a code, and executes the program in a computer. That is, the scope of each of the example embodiments also includes a computer readable storage medium. Further, each of the example embodiments includes not only the storage medium in which the computer program described above is stored but also the computer program itself.

As the storage medium, for example, a floppy (registered trademark) disk, a hard disk, an optical disk, a magneto-optical disk, a compact disc-read only memory (CD-ROM), a magnetic tape, a nonvolatile memory card, or a ROM can be used. Further, the scope of each of the example embodiments includes an example that operates on operating system (OS) to perform a process in cooperation with another software or a function of an add-in board without being limited to an example that performs a process by a subject program stored in the storage medium.

The whole or part of the example embodiments disclosed above can be described as, but not limited to, the following supplementary notes.

### (Supplementary Note 1)

An information processing device comprising:

a detection unit that detects a connection state between at least one POS terminal that is removable from a support stand and the support stand; and

a request unit that, when the connection state is a disconnected state, requests the POS terminal or a user terminal linked in advance to the POS terminal to connect the POS terminal to the support stand.

### (Supplementary Note 2)

The information processing device according to supplementary note 1 further comprising a monitoring unit that monitors a customer in a shop,

wherein the request unit requests the connection when the POS terminal in the disconnected state is present and the number of customers reaches a predetermined number.

### (Supplementary Note 3)

The information processing device according to supplementary note 2, wherein the monitoring unit performs the monitoring by analyzing an image in which the customer is captured in the shop.

### (Supplementary Note 4)

The information processing device according to any one of supplementary notes 1 to 3 further comprising a position acquisition unit that acquires a position of the POS terminal, wherein when a plurality of POS terminals in the disconnected state are present, the request unit requests the POS terminal located at the position closer to the support stand with priority for the connection.

### (Supplementary Note 5)

The information processing device according to supplementary note 4, wherein the position acquisition unit acquires the position via wireless communication with the POS terminal.

### (Supplementary Note 6)

The information processing device according to any one of supplementary notes 1 to 5, wherein the request unit requests the connection when a help request is input from the POS terminal in the connection state to the support stand out of a plurality of POS terminals.

### (Supplementary Note 7)

The information processing device according to any one of supplementary notes 1 to 6, wherein the detection unit detects whether or not the POS terminal and the support stand are electrically and physically connected to each other.

### (Supplementary Note 8)

The information processing device according to any one of supplementary notes 1 to 7, wherein the detection unit detects the connection state via wireless communication with the POS terminal.

### (Supplementary Note 9)

An information processing method comprising:

detecting a connection state between at least one POS terminal that is removable from a support stand and the support stand; and

when the connection state is a disconnected state, requesting the POS terminal or a user terminal linked in advance to the POS terminal to connect the POS terminal to the support stand.

### (Supplementary Note 10)

A storage medium storing a program that causes a computer to perform:

detecting a connection state between at least one POS terminal that is removable from a support stand and the support stand; and

when the connection state is a disconnected state, requesting the POS terminal or a user terminal linked in advance to the POS terminal to connect the POS terminal to the support stand.

This application is based upon and claims the benefit of priority from Japanese Patent Application No. 2018-049503, filed on Mar. 16, 2018, the disclosure of which is incorporated herein in its entirety by reference.

### REFERENCE SIGNS LIST

1, 2 POS system
10, 50, 60, 70, 80, 90 information processing device
10a terminal state detection unit (detection unit)
10b storage unit
10c help request acceptance unit
10d connection request unit (request unit)
10e monitoring unit (monitoring unit)
10f position acquisition unit (position acquisition unit)
10g mode switching request unit
11 access point
12 POS device
13 network
14 user terminal
20 POS terminal
30 support stand
40 peripheral device
101 CPU
102 ROM
103 RAM
104 HDD
105 communication interface
106 input device
107 output device
108 display device
109 bus line

What is claimed is:

1. An information processing device comprising:
a detection unit that detects a connection state between at least one POS terminal that is removable from a support stand and the support stand; and
a request unit that, when the connection state is a disconnected state, requests the POS terminal or a user terminal linked in advance to the POS terminal to connect the POS terminal to the support stand.

2. The information processing device according to claim 1 further comprising a monitoring unit that monitors a customer in a shop,
wherein the request unit requests the connection when the POS terminal in the disconnected state is present and the number of customers reaches a predetermined number.

3. The information processing device according to claim 2, wherein the monitoring unit performs the monitoring by analyzing an image in which the customer is captured in the shop.

4. The information processing device according to claim 1 further comprising a position acquisition unit that acquires a position of the POS terminal,
wherein when a plurality of POS terminals in the disconnected state are present, the request unit requests the POS terminal located at the position closer to the support stand with priority for the connection.

5. The information processing device according to claim 4, wherein the position acquisition unit acquires the position via wireless communication with the POS terminal.

6. The information processing device according to claim 1, wherein the request unit requests the connection when a help request is input from the POS terminal in the connection state to the support stand out of a plurality of POS terminals.

7. The information processing device according to claim 1, wherein the detection unit detects whether or not the POS terminal and the support stand are electrically and physically connected to each other.

8. The information processing device according to claim 1, wherein the detection unit detects the connection state via wireless communication with the POS terminal.

9. An information processing method comprising:
detecting a connection state between at least one POS terminal that is removable from a support stand and the support stand; and
when the connection state is a disconnected state, requesting the POS terminal or a user terminal linked in advance to the POS terminal to connect the POS terminal to the support stand.

10. A non-transitory storage medium storing a program that causes a computer to perform:
detecting a connection state between at least one POS terminal that is removable from a support stand and the support stand; and
when the connection state is a disconnected state, requesting the POS terminal or a user terminal linked in advance to the POS terminal to connect the POS terminal to the support stand.
